(19) United States
(12) Patent Application Publication
(10) Pub. No.: US 2026/0070357 A1
(43) Pub. Date: Mar. 12, 2026

(54) PRINTING APPARATUS

(71) Applicant: CANON KABUSHIKI KAISHA, Tokyo (JP)

(72) Inventors: TOSHIAKI SOMANO, Kanagawa (JP); SHO TAKAHASHI, Kanagawa (JP); TETSU HAMANO, Tokyo (JP); YUKI EMOTO, Tokyo (JP); MOTOYUKI TAGUCHI, Tokyo (JP)

(21) Appl. No.: 19/324,426

(22) Filed: Sep. 10, 2025

(30) Foreign Application Priority Data
Sep. 11, 2024 (JP) 2024-157729

(51) Int. Cl. B41J 13/10; B41J 2/165; B41J 2/17; B41J 11/00; B41J 29/13; B41J 29/46

(52) U.S. Cl. CPC B41J 13/103; B41J 2/16517; B41J 2/1721; B41J 11/006; B41J 29/13; B41J 29/46

(57) ABSTRACT

A printing apparatus comprising a printhead, at least one conveyance unit, and a storage cassette configured to store a print medium and be inserted/removed into/from an apparatus main body, wherein the at least one conveyance unit includes a detachable unit configured to form part of a conveyance path of the print medium and be detachable from the apparatus main body, the detachable unit is exposed by removing the storage cassette from the apparatus main body, and in a case where the storage cassette is pulled out from a first position at which the storage cassette is inserted into the apparatus main body, the storage cassette is configured to be held at a second position at which the detachable unit can be detached from the apparatus main body.

### BACKGROUND

### Field of the Technology

The present disclosure relates mainly to a printing apparatus.

### Description of the Related Art

A printing apparatus typified by an inkjet printer sometimes requires a predetermined maintenance in order to continue a proper use.

For example, Japanese Patent Laid-Open No. 2002-154674 describes the arrangement of a sheet feed apparatus capable of pulling out a sheet feed cassette in two stages. According to Japanese Patent Laid-Open No. 2002-154674, the sheet feed cassette is replenished with sheets in a state in which the sheet feed cassette is pulled out to the first stage. When a jam (paper jam) occurs in the sheet feed mechanism, maintenance is performed in a state in which the sheet feed cassette is pulled out to the second stage.

Japanese Patent Laid-Open No. 2010-012652 describes the arrangement of a printing apparatus in which an opening/closing cover is provided at a front portion and an ink cartridge or a drainage tank can be replaced by opening the opening/closing cover. According to Japanese Patent Laid-Open No. 2010-012652, the operation of the printing apparatus stops upon detecting that the opening/closing cover is opened.

In general, maintenance needs to be implemented properly and easily. From this viewpoint, the arrangements in Japanese Patent Laid-Open No. 2002-154674 and Japanese Patent Laid-Open No. 2010-012652 have room for improvement.

### SUMMARY

The present disclosure implements, by a relatively simple arrangement, a structure capable of more properly and easily performing maintenance of the inside of a printing apparatus.

One of the aspects of the present disclosure provides a printing apparatus, comprising a printhead configured to print on a print medium, and at least one conveyance unit configured to convey a print medium, the apparatus further comprising a storage cassette configured to store a print medium and be inserted/removed into/from an apparatus main body, wherein the at least one conveyance unit includes a detachable unit configured to form part of a conveyance path of the print medium and be detachable from the apparatus main body, the detachable unit is exposed by removing the storage cassette from the apparatus main body, and the storage cassette is configured to be held at a second position at which the detachable unit can be detached from the apparatus main body in a case where the storage cassette is pulled out from a first position at which the storage cassette is inserted into the apparatus main body.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are schematic views showing the overall arrangement of a printing apparatus according to an embodiment;

FIGS. 2A and 2B are schematic views showing the arrangement of the printing apparatus;

FIGS. 3A, 3B, and 3C are schematic views showing the detachment form of a storage cassette in the printing apparatus;

FIGS. 4A and 4B are schematic views showing the outer appearances of the printing apparatus and storage cassette;

FIG. 5 is a schematic view showing the intermediate pullout state of the storage cassette;

FIG. 6 is a schematic view showing the internal arrangement of the printing apparatus in a state in which a detachable unit is detached;

FIG. 7 is a schematic view showing the outer appearance of the detachable unit;

FIG. 8 is a schematic view showing a form in which the detachable unit is detached to perform maintenance while the storage cassette is in the intermediate pullout state;

FIG. 9 is a schematic view showing a form in which a waste ink tank is detached to perform maintenance while the storage cassette is in the intermediate pullout state;

FIG. 10 is a perspective view of the printing apparatus in a state in which an ink tank cover is detached;

FIG. 11 is a perspective view of the printing apparatus in a state in which the storage cassette is detached; and

FIGS. 12A and 12B are schematic views showing the overall arrangement of a printing apparatus according to another embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### (Overall Arrangement of Printing Apparatus)

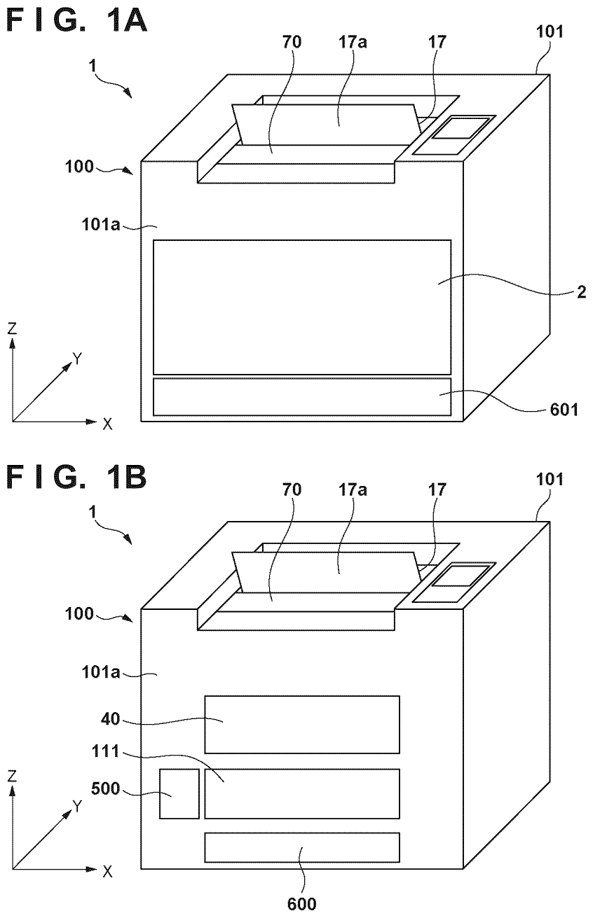

FIG. 1A is a view of the outer appearance of a printing apparatus 1 according to the first embodiment. For easy understanding of the structure, X, Y, and Z directions crossing (substantially orthogonal to) each other are shown in FIG. 1A, which also applies to the remaining drawings (to be described later). In this embodiment, the X direction corresponds to the left-and-right direction or the direction of width, the Y direction corresponds to the front-and-back direction or the direction of depth, and the Z direction corresponds to the up-and-down direction or the direction of height.

Here, the −X side is the left side, the +X side is the right side, the −Y side is the near side/front side, the +Y side is the far side/rear side, the −Z side is the down side, and the +Z side is the up side. In the following description, however, when one side or the other need not be discriminated, a direction will be simply indicated as the X, Y, or Z direction. Both the X and Y directions may be expressed as a horizontal direction, and the Z direction may be expressed as a vertical direction.

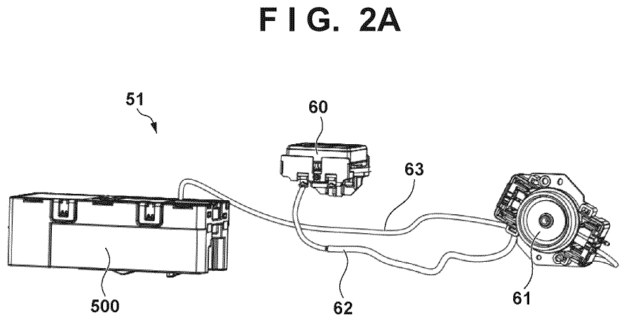

In this embodiment, the printing apparatus 1 is an inkjet printer that, while relatively moving a printhead 12 with respect to a sheet SH (which is typically a paper material but may be another sheet-like print medium; to be described later), drives the printhead 12 to discharge ink and print (see FIG. 2B). Note that the printing apparatus 1 may be a copying machine having a print function as a main function and further having, as sub-functions, a copy function, a scanner function, and a facsimile function.

In this embodiment, printing is implemented by alternately repeating an operation (intermittent conveyance) of conveying the sheet SH only by a predetermined amount, and an operation (print scanning) of scanning the printhead 12 in a direction crossing the conveyance direction of the sheet SH and discharging ink while suppressing the conveyance. The printhead 12 is expressed as a serial head.

As another embodiment, the printhead 12 may be a line head capable of printing at once in the entire area of the sheet SH in the direction of width.

By such printing, a desired image can be printed on the sheet SH. The concept of an image includes a character, a numeral, a sign, a figure, a photograph, and the like, regardless of whether the image is visible. Although ink is typically a liquid containing dye or pigment, it may be a colorless and transparent reactive liquid or may be expressed as a liquid including them. From this viewpoint, the printing apparatus 1 may be expressed as a liquid discharge apparatus. Similarly, the printhead 12 may be expressed as a liquid discharge head.

As shown in FIG. 1A, the printing apparatus 1 includes a storage cassette 2 and an ink tank cover 601.

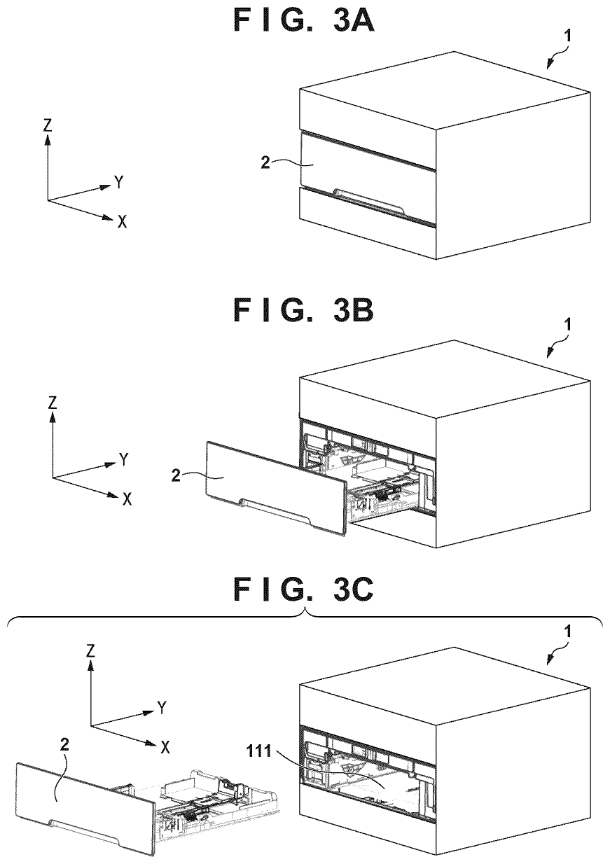

The storage cassette 2 is configured to store one or more sheets SH, details of which will be described later (see FIG. 2B). The storage cassette 2 is attached to a main body (apparatus main body) 100 of the printing apparatus 1 demarcated by a housing 101 so as to be insertable/removable in the Y direction. A cover member 2c (see FIG. 4B) of the storage cassette 2 forms part of a front portion 101a of the housing 101.

The ink tank cover 601 is a cover member for sealing an ink tank 600 (to be described later) attached inside the apparatus main body 100 (see FIG. 2B). The ink tank cover 601 is detachably attached to the apparatus main body 100 below the storage cassette 2, and forms another part of the front portion 101a.

In the above description, insertion/removal means insertion and removal, and attachment/detachment means attachment and detachment in order to discriminate insertion/removal and attachment/detachment from each other. However, attachment/detachment is a concept including insertion/removal. For descriptive convenience, insertion or removal (or insertion/removal) is sometimes expressed as attachment or detachment (attachment/detachment). Depending on the moving distance and/or moving direction of a target, attachment/detachment and insertion/removal are interchangeable.

FIG. 1B shows the printing apparatus 1 in a state in which the storage cassette 2 and the ink tank cover 601 are detached. The printing apparatus 1 further includes a slot 111, a detachable unit 40, a waste ink tank 500, and the ink tank 600.

The slot 111 extends in the Y direction so that the storage cassette 2 can be inserted, and thus may be expressed as a storage cassette slot. The detachable unit 40 is detachably arranged above the slot 111 in a state in which the storage cassette 2 is detached, and the user can detach the detachable unit 40 at the time of maintenance (to be described later). The waste ink tank 500 is detachably arranged beside the slot 111 in a state in which the storage cassette 2 is detached, and the user can detach the waste ink tank 500 at the time of another maintenance.

The ink tank 600 is detachably arranged below the slot 111 in a state in which the ink tank cover 601 is detached, and the user can detach the ink tank 600 at the time of still another maintenance. Note that the ink tank 600 is configured to store one or more ink bags/ink bottles, and when inks of a plurality of colors are used, ink bags/ink bottles are stored for the respective colors.

That is, the slot 111, the detachable unit 40, and the waste ink tank 500 are exposed by detaching the storage cassette 2, and the ink tank 600 is exposed by detaching the ink tank cover 601. If necessary, the user can detach the storage cassette 2 and/or the ink tank cover 601 on the front side of the printing apparatus 1 to perform various maintenances, details of which will be described later. With this arrangement, the user need not go behind the printing apparatus 1 at the time of various maintenances, and the printing apparatus 1 is advantageous for improving the usability.

Note that the waste ink tank 500 is positioned on the left side of the slot 111 in this embodiment, but suffices to be positioned near the slot 111.

As shown in FIGS. 1A and 1B, a discharge tray 17 on which the sheet SH discharged outside the apparatus main body 100 is placed is provided at the upper portion of the housing 101, and the printed sheets SH are sequentially stacked on the discharge tray 17. An opening 70 is provided at the upper portion of the housing 101, and the discharge tray 17 includes an opening/closing portion 17a attached to the housing 101 so that the opening 70 can be opened/closed. The opening/closing portion 17a can open/close the opening 70 by pivot about a shaft parallel to the X direction that is a pivot shaft 17b.

The open state and closed state of the opening/closing portion 17a respectively correspond to the open state and closed state of the opening 70, and also respectively correspond to the open state and closed state of the inside of the apparatus main body 100. Note that FIGS. 1A and 1B show the open state of the opening/closing portion 17a, and FIG. 2B shows the closed state of the opening/closing portion 17a. The user can access the inside of the apparatus main body 100 from the opening 70 opened by the opening/closing portion 17a to perform still another maintenance, a detailed description of which will be omitted here.

### (Arrangement of Recovery Unit)

FIG. 2A is a perspective view showing the arrangement of the waste ink tank 500 and that of a recovery unit 51 which is connected to the waste ink tank 500 and includes several elements in the apparatus main body 100. The recovery unit 51 includes a cap 60, a suction pump 61, and tubes 62 and 63.

The cap 60 is so arranged that it can face the printhead 12. The cap 60 can cap the printhead 12 (ink discharge surface of the printhead 12) that is moved to a retraction position when no printing is performed. In this embodiment, the cap 60 moves up by an elevating mechanism (not shown) to cap the printhead 12, and moves down to cancel the capping.

The suction pump 61 is connected to the cap 60 via the tube 62, and can suck, via the tube 62, ink in the printhead 12 capped with the cap 60. The sucked ink is sent under pressure as waste ink to the waste ink tank 500 via the tube 63, and is retained.

With this arrangement, the recovery unit 51 can keep ink fresh in the printhead 12, and recover the function of the printhead 12. When the amount of waste ink in the waste ink tank 500 reaches a reference amount, the user can detach the storage cassette 2 and replace the waste ink tank 500.

### (Arrangement of Conveyance Mechanism)

FIG. 2B is a schematic sectional view showing the internal arrangement of the printing apparatus 1. The printing apparatus 1 further includes a printing unit 10 and conveyance units 3 to 8.

The printing unit 10 includes the printhead 12, a carriage 11, and a driving unit 14. The printhead 12 is so arranged that it can face a platen 15 supporting the sheet SH during conveyance. The carriage 11 can support the printhead 12, and reciprocate in the X direction so that the printhead 12 can be scanned in the X direction. The driving unit 14 is a belt power transmission mechanism that reciprocates the carriage 11 based on power of a carriage motor 21, but may be another known power transmission mechanism. Print scanning of the printhead 12 can be implemented by this arrangement.

The driving unit 14 and its peripheral components are supported by a support member 20 extending in the X direction. A guide member 13 that implements reciprocation of the carriage 11 is provided on the support member 20. In this embodiment, the guide member 13 includes a lower rail member 13a and an upper rail member 13b. The rail members 13a and 13b are spaced apart from each other in the Z direction, and both extend in the X direction X so that they can engage with the carriage 11 and reciprocate the carriage 11.

In this embodiment, a position of the rail member 13a in the Z direction can be adjusted so that the height of the printhead 12 with respect to the platen 15 can be adjusted. A position of the rail member 13b in the Y direction can be adjusted so that the posture of the printhead 12 with respect to the platen 15 can be adjusted.

Ink is supplied from the ink tank 600 to the printing unit 10 via a tube (not shown), and the printing unit 10 can perform print scanning with this arrangement.

The conveyance units 3 to 8 are arranged at corresponding positions within the apparatus main body 100 along the conveyance path of the sheet SH, convey the sheet SH in the storage cassette 2 toward the printing unit 10, and further convey the printed sheet SH toward the discharge tray 17. In this embodiment, the conveyance units 3 to 8 are arranged sequentially from the upstream side to downstream side of the conveyance path of the sheet SH. Each of the conveyance units 3 to 8 is typically constituted by arranging a pair of one or more rotation members, details of which will be described later.

Note that the upstream side in this specification means a side near the storage cassette 2 on the conveyance path of the sheet SH, and the downstream side means a side near the discharge tray 17 on the conveyance path.

The conveyance units 3 and 4 are arranged on the upstream side of the printing unit 10, and can convey the sheet SH from the storage cassette 2 toward the downstream side. The conveyance unit 3 picks up one by one the sheets SH stacked on a sheet feed tray 2a within the storage cassette 2, and conveys it to the downstream side. The conveyance unit 4 conveys further to the downstream side the sheet SH received from the conveyance unit 3.

The conveyance units 5 and 6 are arranged respectively on the upstream side and downstream side of the printing unit 10, and can selectively execute intermittent conveyance and constant-speed conveyance of the sheet SH. The constant-speed conveyance means conveying the sheet SH at a substantially constant speed without performing intermittent conveyance (not accompanied by suppression of conveyance of the sheet SH). For example, while printing is performed on the sheet SH, the conveyance units 5 and 6 perform intermittent conveyance in cooperation with each other. For double-sided printing, the conveyance units 5 and 6 can convey (return) toward the upstream side at a substantially constant speed the sheet SH having only one surface printed, details of which will be described later.

The conveyance units 7 and 8 are arranged on the downstream side of the printing unit 10, and can convey further toward the downstream side the sheet SH printed by the printing unit 10. The conveyance unit 7 conveys to the downstream side the sheet SH received from the conveyance unit 6. The conveyance unit 8 conveys further to the downstream side the sheet SH received from the conveyance unit 7, and discharges it outside the apparatus main body 100.

Note that the respective conveyance units 3 to 8 may be expressed by other names for discrimination. For example, the conveyance units 3 and 4 may be expressed as sheet feed units to discriminate them from the remaining conveyance units. Also, the conveyance units 7 and 8 may be expressed as discharge units to discriminate them from the remaining conveyance units.

The conveyance path of the sheet SH in the apparatus main body 100 includes a main conveyance path RT1 and a sub-conveyance path RT2. The main conveyance path RT1 is a path from the storage cassette 2 to the discharge tray 17. For single-sided printing (a case where printing is performed on only one surface of the sheet SH), the sheet SH passes through the main conveyance path RT1.

The sub-conveyance path RT2 is another path connected to the main conveyance path RT1. For double-sided printing (a case where printing is performed on both one and the other surfaces of the sheet SH), the sheet SH further passes through the sub-conveyance path RT2. More specifically, the sheet SH having one surface printed passes through the printing unit 10 by the conveyance units 6 to 8, is returned to the conveyance unit 5, and guided to the sub-conveyance path RT2 by a switching flapper. Then, the sheet SH is conveyed again toward the printing unit 10 by the conveyance unit 4, and the printing unit 10 prints on the other surface of the sheet SH turned over during the conveyance. The sheet SH having one and the other surfaces printed in this manner is conveyed to the downstream side by the conveyance units 6 to 8, discharged outside the apparatus main body 100, and placed on the discharge tray 17.

Each of the conveyance units 3 to 8 is arranged along the conveyance path, typically constituted by arranging paired rotation members to face each other, and includes a driving roller and a driven rotation member (in this embodiment, a driven roller or a driven spur) facing the driving roller. The driven rotation member contacts the driving roller under pressure by a predetermined biasing means so that it can properly convey the sheet SH while pinching the sheet SH.

In this embodiment, the conveyance unit 3 includes a pickup roller 3a, a feed roller 3b, and a separation roller 3c. The pickup roller 3a picks up one by one the sheets SH stacked on the sheet feed tray 2a based on power of a motor 22. The feed roller 3b and the separation roller 3c face each other. The feed roller 3b conveys the picked-up sheet SH based on power of the motor 22 while pinching the sheet SH together with the separation roller 3c. A torque limiter is provided for the separation roller 3c, and when two or more sheets SH are picked up (so-called multi-feed occurs), the remaining sheets SH other than one sheet SH to be conveyed are separated from the sheet SH, and returned to the sheet feed tray 2a.

The conveyance unit 4 includes a roller pair 4′ constituted by arranging a driving roller 4′a and a driven roller 4′b to face each other, and a roller pair 4″ constituted by arranging a driving roller 4″a and a driven roller 4″b to face each other. The driving rollers 4′a and 4″a rotate based on power of a motor 23. The main conveyance path RT1 is formed to be curved near the conveyance unit 4. To implement this, conveyance path formation members 40a and 40b that respectively form an inner wall and an outer wall are arranged.

The conveyance unit 5 includes a roller pair constituted by arranging a driving roller 5a and a driven roller 5b to face each other. The conveyance unit 6 includes a rotation member pair 6′ constituted by arranging a driving roller 6′a and a driven spur 6′b to face each other, and a rotation member pair 6″ constituted by arranging a driving roller 6″a and a driven spur 6″b to face each other. The driving rollers 5a, 6′a, and 6″a rotate based on power of a motor 24. The main conveyance path RT1 extends substantially straightly between the conveyance units 5 and 6.

The conveyance unit 7 includes a rotation member pair constituted by arranging a driving roller 7a and a driven spur 7b to face each other. The conveyance unit 8 includes a rotation member pair constituted by arranging a driving roller 8a and a driven spur 8b to face each other. The driving rollers 7a and 8a rotate based on power of a motor 25. The main conveyance path RT1 curves and extends upward between the conveyance units 7 and 8, and the printed sheet SH is discharged in a posture in which the finally printed surface (one surface in single-sided printing, and the other surface in double-sided printing) faces down. This discharge form of the sheet SH is also expressed as facedown discharge.

Note that the rotation member facing the driving roller may be a roller or a spur. Typically, a roller is used on the upstream side of the printing unit 10, and a spur is used on the downstream side of the printing unit 10. As the spur, a rotation member of another shape may be used.

The printing apparatus 1 further includes sensors 31 to 34 capable of detecting the presence/absence of the sheet SH. As the sensors 31 to 34, known optical sensors are available. The sensor 31 is arranged near the conveyance unit 4, the sensor 32 is arranged near the conveyance unit 5, the sensor 33 is arranged near the conveyance unit 6, and the sensor 34 is arranged near the conveyance unit 8. The respective sensors 31 to 34 detect the pass of the leading end and trailing end of the sheet SH at corresponding positions. The conveyance form of the sheet SH can be changed based on the detection results of the sensors 31 to 34.

As an example, when the sensor 31 detects the leading end of the sheet SH, driving of the conveyance unit 3 is stopped to suppress conveyance of the next sheet SH. When the sensor 32 detects the leading end of the sheet SH, the driving amounts of the conveyance units 4 and 5 (conveyance amount of the sheet SH) are adjusted to align the sheet SH. When the sensor 33 detects the trailing end of the sheet SH, the conveyance units 7 and 8 are controlled to discharge the sheet SH. When the sensor 34 detects the trailing end of the sheet SH, the completion of discharge of the sheet SH is specified, and if necessary, a printing completion notification can be output.

### (Maintenance of Printing Apparatus)

As described above, the user can detach the storage cassette 2 and/or the ink tank cover 601 to perform a predetermined maintenance.

### —Maintenance of Storage Cassette

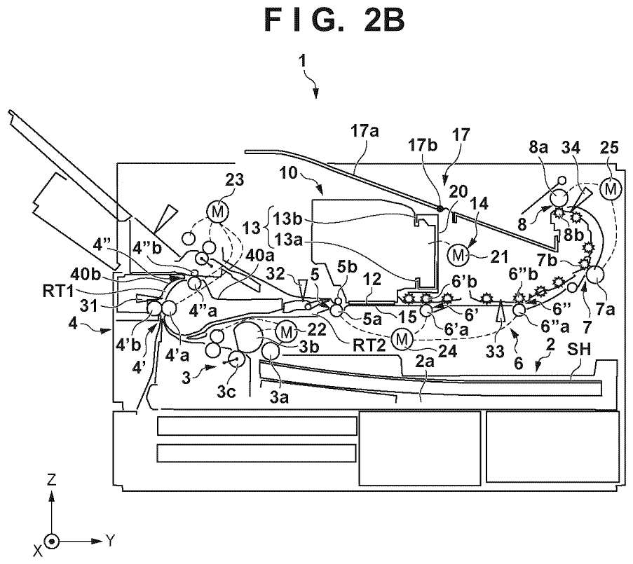

FIGS. 3A, 3B, and 3C are perspective views of the printing apparatus 1 in a state before the storage cassette 2 is detached, a state in which the storage cassette 2 is pulled out halfway, and a state in which the storage cassette 2 is detached. FIGS. 4A and 4B are a perspective view of the printing apparatus 1 in a state in which the storage cassette 2 is detached, and a perspective view of the detached storage cassette 2, respectively.

As shown in FIGS. 4A and 4B, rails 80a and 80b that support the storage cassette 2 slidably in the Y direction are provided on two sides in the X direction in the slot 111, and can guide movement of the storage cassette 2 at the time of attachment/detachment.

Of the rollers 3a, 3b, and 3c of the conveyance unit 3, the pickup roller 3a and the feed roller 3b are rotatably held on the apparatus main body 100 side, and the separation roller 3c is rotatably held on the storage cassette 2 side. When the storage cassette 2 is detached, the separation roller 3c is detached from the apparatus main body 100 together with the storage cassette 2, partially dividing the conveyance unit 3.

With this arrangement, the user can detach the storage cassette 2, access the inside of the slot 111, and replace the pickup roller 3a and the feed roller 3b. The pickup roller 3a and the feed roller 3b may be replaceable individually or may be unitized so that they can be simultaneously replaced. In contrast, the separation roller 3c is attached to a separation roller holder 95 in the storage cassette 2. The user can detach the separation roller holder 95 from the storage cassette 2 or detach the separation roller 3c from the separation roller holder 95 to replace the separation roller 3c.

In the storage cassette 2, a press plate 91 is provided on the sheet feed tray 2a via a biasing means (not shown), and can press the sheets SH stacked on the sheet feed tray 2a against the pickup roller 3a. More specifically, the press plate 91 is substantially horizontal (substantially parallel to the upper surface of the sheet feed tray 2a) in the state of FIG. 4B in which the storage cassette 2 is detached. When detaching the storage cassette 2, press plate cams 83 provided on two sides in the X direction X in the slot 111 press the two end portions of the press plate 91, and the thus moved-down press plate 91 is held by a predetermined press plate holding portion provided in the storage cassette 2. When attaching the storage cassette 2, the holding of the press plate 91 by the press plate holding portion is released by a press plate release lever 96 in the slot 111. In this manner, the press plate 91 can press the sheet SH on the sheet feed tray 2a against the pickup roller 3a.

Side guides 85 and 86 and an end guide 89 for regulating the sheet SH to be stored in accordance with its size are provided in the storage cassette 2.

The side guides 85 and 86 are coupled to each other by a rack and a pinion (neither is shown) below the press plate 91. When one of the side guides 85 and 86 is moved, the other can move in synchronization with it, thereby regulating a position of the sheet SH in the direction of width. In this embodiment, biasing plates 88 biased in the X direction by biasing means (not shown) are provided on the side guide 85, and can regulate the sheet SH stacked on the sheet feed tray 2a in the direction of width. A side lock 87 is provided on the side guide 86, and can fix the position of the side guide 86.

The end guide 89 regulates a position of the sheet SH in the direction of length (conveyance direction). An end lock 90 including a latch 90a is provided at the center of the end guide 89, and can fix the position of the end guide 89.

### —Maintenance Against Jam (Paper Jam)

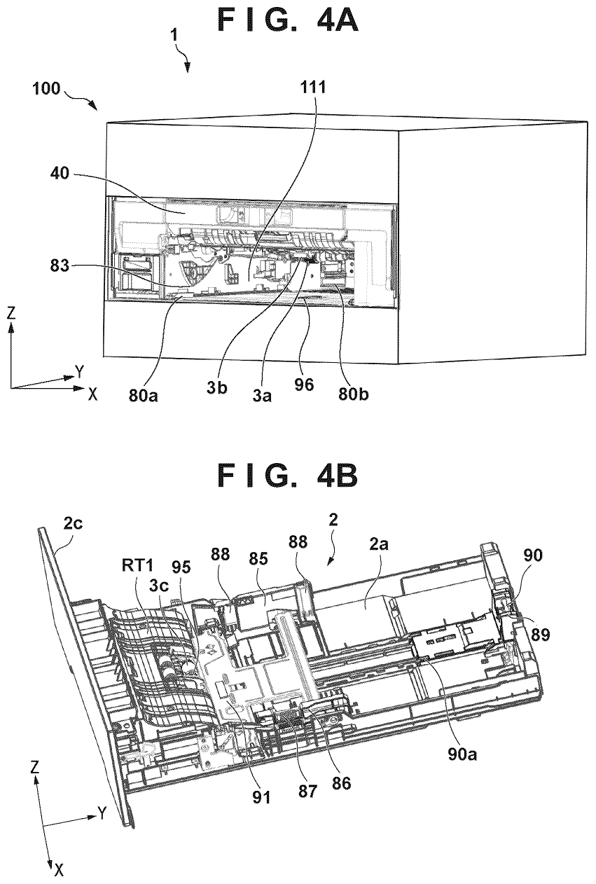

FIG. 5 is a schematic view showing the positional relationship of the storage cassette 2 in the slot 111 in a state (see FIG. 3B) in which the storage cassette 2 is pulled out halfway. A rail abutment portion 80a1 is provided on the rail 80a, and a cassette abutment portion 2b against which the rail abutment portion 80a1 abuts during sliding is provided on the storage cassette 2. At the time of detachment, the cassette abutment portion 2b abuts against the rail abutment portion 80a1 to hold the storage cassette 2 in a state in which the storage cassette 2 is pulled out halfway. From this viewpoint, the cassette abutment portion 2b and the rail abutment portion 80a1 function as a positioning portion that determines a position where the storage cassette 2 can be held in a state in which it is pulled out halfway.

The cassette abutment portion 2b and the rail abutment portion 80a1 may be simply expressed as abutment portions, or the rail abutment portion 80a1 out of them may be expressed as an abut portion. As other expressions, the cassette abutment portion 2b may be expressed as an engaging portion, an abutting portion, or the like, and the rail abutment portion 80a1 may be expressed as an engaged portion, an abut portion, or the like. The state in which the cassette abutment portion 2b abuts against the rail abutment portion 80a1 may be expressed as an intermediate pullout state, and the position of the storage cassette 2 at that time may be expressed as an intermediate position.

Note that the abutment portions 2b and 80a1 suffice to be provided so that the storage cassette 2 is held at the intermediate position. For example, instead of the rail abutment portion 80a1, another abutment portion that abuts against the cassette abutment portion 2b may be provided at any portion within the slot 111.

When further pulling out and detaching the storage cassette 2, the user raises the storage cassette 2 to separate the cassette abutment portion 2b from the rail abutment portion 80a1 and then pull out the storage cassette 2. The holding of the storage cassette 2 at the intermediate position is not limited to this example, and may be implemented by another known stopper.

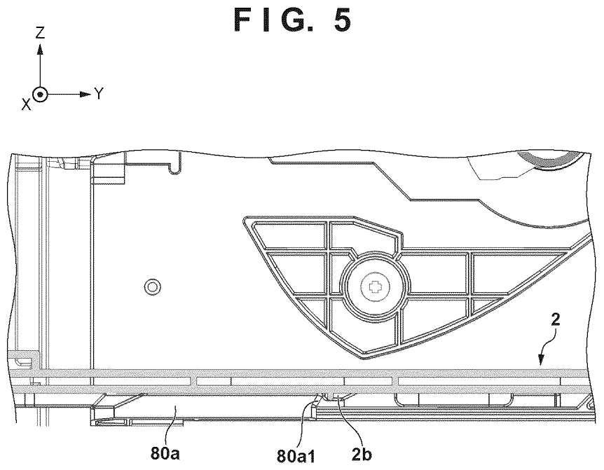

FIG. 6 is a schematic sectional view showing the internal arrangement of the printing apparatus 1 in a state in which the detachable unit 40 is detached. The detachable unit 40 is so constituted as to partially include a part between the conveyance units 4 and 5 out of the conveyance path of the sheet SH, and its periphery. In this embodiment, the detachable unit 40 includes the conveyance path formation members 40a and 40b that respectively form the inner wall and outer wall of a curved part of the main conveyance path RT1, and the rollers 4′a, 4′b, and 4″a arranged on it/them. The detachable unit 40 forms part of the main conveyance path RT1, and also forms part of the conveyance unit 4 because the detachable unit 40 includes the rollers 4′a, 4′b, and 4″a.

With this arrangement, when a jam occurs on the conveyance path between the conveyance units 4 and 5 and its periphery, the user can detach the detachable unit 40 to perform maintenance of removing the sheet (jammed sheet) SH in the jam state.

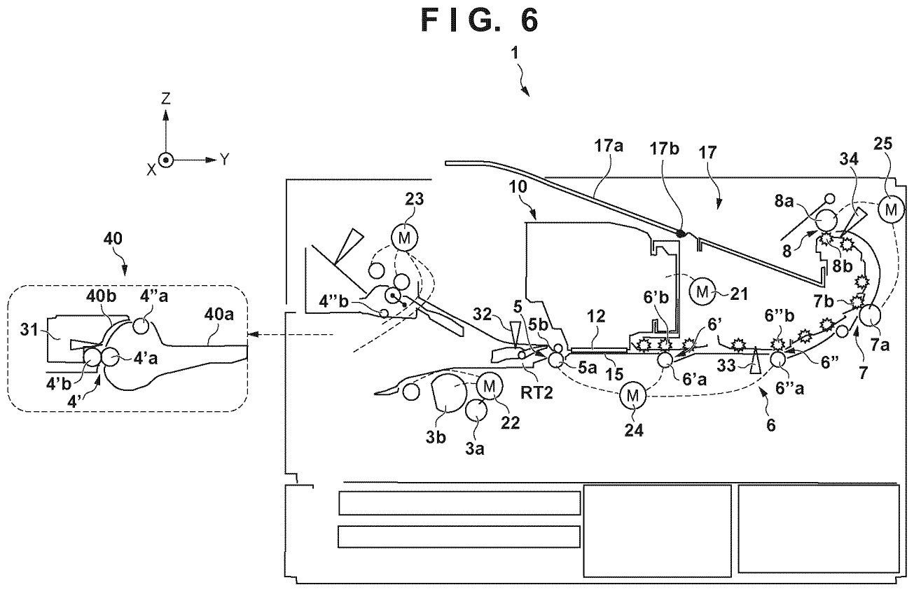

FIG. 7 is a perspective view of the detachable unit 40. The detachable unit 40 includes gripping portions 41 and 42 on a front surface 43. A biasing means (not shown) for biasing the gripping portions 41 and 42 outward is built in between the gripping portions 41 and 42. The user can detach the detachable unit 40 while gripping the gripping portions 41 and 42 so as to press them in a direction opposite to the biasing direction.

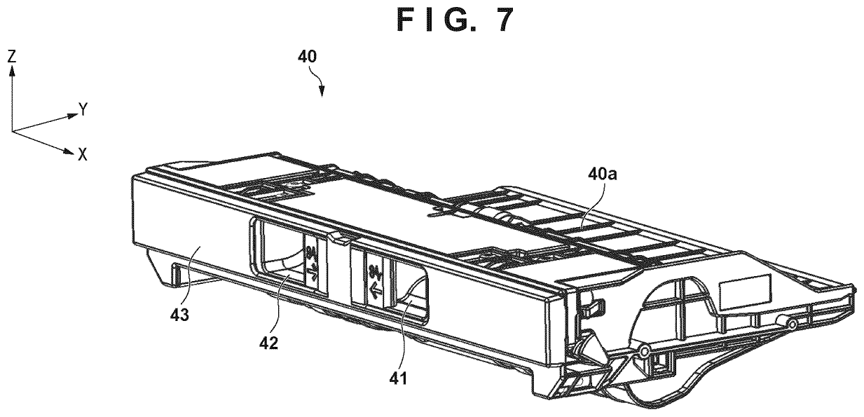

FIG. 8 shows a form in which the detachable unit 40 is detached so that the sheet SH can be removed while the storage cassette 2 is in the intermediate pullout state (see FIG. 5). Letting N be a size of the detachable unit 40 in the Y direction when viewed from the side (when viewed in the X direction), and L be the pullout amount of the storage cassette 2 from the apparatus main body 100 in the intermediate pullout state, the intermediate position of the storage cassette 2 is set to establish N<L.

When the storage cassette 2 is pulled out up to the intermediate position, the cassette abutment portion 2b abuts against the rail abutment portion 80a1, and the storage cassette 2 is held in the intermediate pullout state. While keeping the storage cassette 2 in the intermediate pullout state, the user can detach the detachable unit 40 and remove the jammed sheet SH. In removing the jammed sheet SH, the user need not pull out the storage cassette 2 to the end and detach it. Thus, an extra space for temporarily placing the storage cassette 2 need not be prepared. Further, in removing the jammed sheet SH, the storage cassette 2 in the intermediate pullout state is positioned below the detachable unit 40, so the user does not drop the detachable unit 40 owing to erroneous handling. According to this embodiment, the printing apparatus 1 is advantageous for improving the usability at the time of maintenance.

### —Maintenance for Replacement of Waste Ink Tank

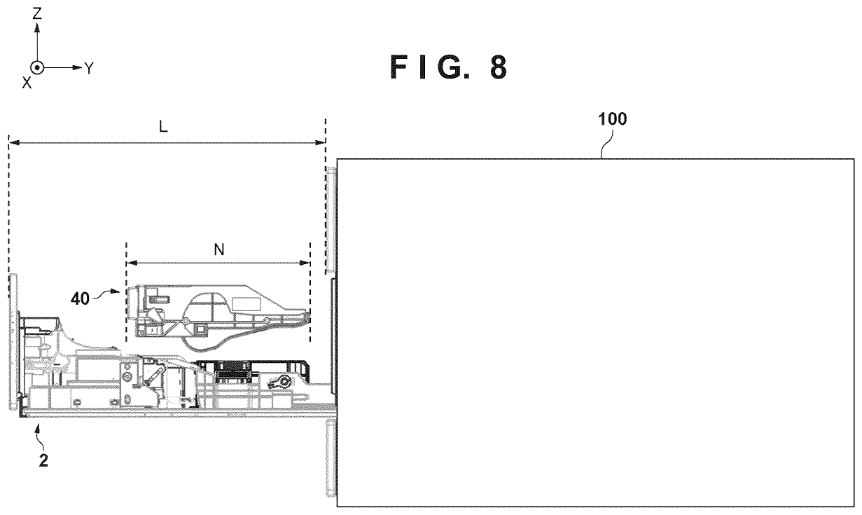

As shown in FIG. 9, the user can also perform maintenance for replacing the waste ink tank 500 while the storage cassette 2 is in the intermediate pullout state. Letting M be a size of the waste ink tank 500 in the Y direction when viewed from the side, the intermediate position of the storage cassette 2 is set to further establish M<L.

The waste ink tank 500 incorporates an electronic component (not shown). When the waste ink tank 500 is attached to the apparatus main body 100, this can be specified based on the energization state of the electronic component. The electronic component can include, for example, a counter that measures the amount of waste ink in the waste ink tank 500, and a memory that stores the result of the measurement. When the waste ink amount reaches a reference amount, the electronic component can output, to the apparatus main body 100, a signal representing that the waste ink tank 500 needs to be replaced. The printing apparatus 1 can output a notification based on the signal, and the user can replace the waste ink tank 500 in accordance with the notification.

### —Maintenance for Replacement of Ink Tank

When the remaining amount of ink in the ink tank 600 becomes smaller than a reference amount, the user can detach the ink tank cover 601 to access the ink tank 600 and replenish it with ink. The replenishment with ink can be implemented by replacing an ink bag/ink bottle contained in the ink tank 600.

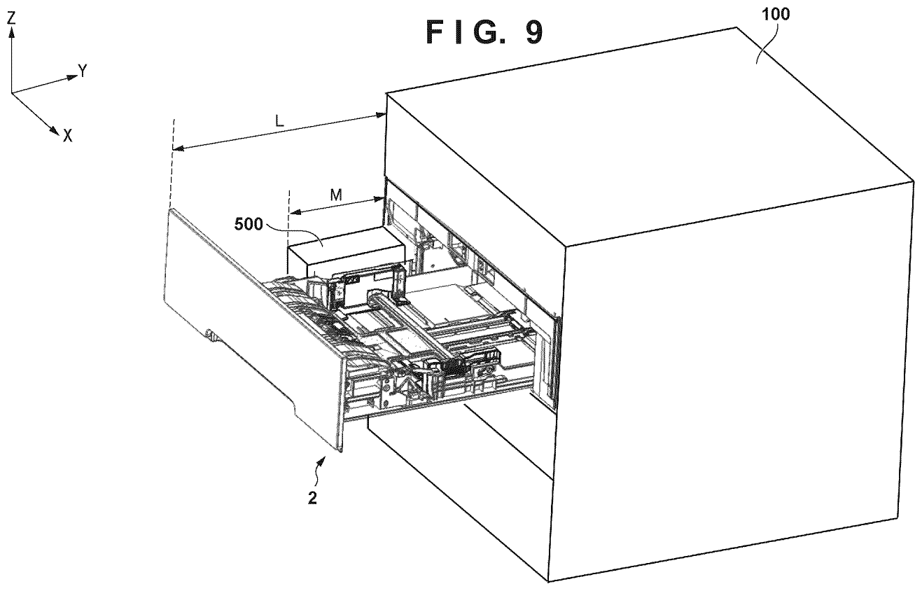

FIG. 10 is a perspective view showing the printing apparatus 1 in a state in which the ink tank cover 601 is detached while the storage cassette 2 is kept attached. The attachment/detachment of the ink tank cover 601 is detected by a sensor (not shown). When the sensor detects that the ink tank cover 601 has been detached, execution of printing is suppressed, allowing replenishment with ink.

During the replenishment with ink, the storage cassette 2 is kept attached, so access to the waste ink tank 500 by the user is restricted, that is, the waste ink tank 500 is kept attached. During the replenishment with ink, the recovery unit 51 can recover the function of the printhead 12, thereby continuing appropriate printing and reducing the downtime.

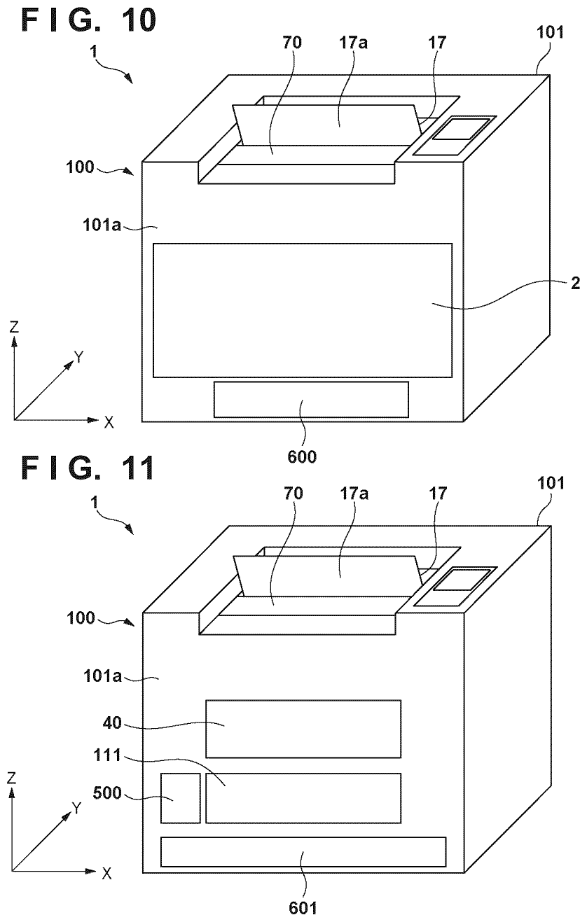

FIG. 11 is a perspective view showing the printing apparatus 1 in a state in which the storage cassette 2 is detached while the ink tank cover 601 is kept attached. Since the waste ink tank 500 is kept attached in this state, the recovery unit 51 can execute recovery. That is, whether recovery by the recovery unit 51 can be executed is not related to the insertion/removal state of the storage cassette 2.

For example, the attachment/detachment of the storage cassette 2 is detected by a sensor (not shown). When the sensor detects, during execution of recovery by the recovery unit 51, that the storage cassette 2 has been detached, recovery by the recovery unit 51 may continue. In this case, a predetermined notification may be output so that the user can recognize that the storage cassette 2 has been detached. Hence, the user can replenish the storage cassette 2 with the sheets SH, whereas erroneous detachment of the waste ink tank 500 during execution of recovery by the recovery unit 51 can be prevented.

Alternatively, when the sensor detects that the storage cassette 2 has been detached, recovery by the recovery unit 51 may be interrupted. In this case, the user can replace the waste ink tank 500. Also, when the sensor detects that the storage cassette 2 has been detached, whether the waste ink tank 500 needs to be replaced may be determined, and whether recovery by the recovery unit 51 can be executed may be decided.

Similarly, when the sensor detects, during execution of print scanning by the printhead 12, that the storage cassette 2 has been detached, print scanning on the sheet SH by the printhead 12 may continue. In this case, printing on the sheet SH continues, whereas printing on the next sheet SH does not start (supply of the next sheet SH is suppressed).

Note that the above operation can be implemented by the sensor used to detect attachment/detachment of the storage cassette 2, and no additional sensor need be arranged for the determination.

In this fashion, a plurality of maintenance targets are sealed by different sealing means (in this example, the storage cassette 2 and the ink tank cover 601) in accordance with the application or purpose, and sealing of the maintenance targets can be canceled by the respective sealing means. When some elements need to be maintained and corresponding sealing is canceled, the functions of the remaining elements (for example, recovery by the recovery unit 51 and printing in execution by the printhead 12) can sometimes continue. In this arrangement, a component (for example, a sensor) may be omitted.

It is only necessary to perform the above-described control by a system controller capable of exchanging signals with each element in the printing apparatus 1. The arithmetic processing suffices to be performed in a known form by a central processing unit (CPU) and a memory.

### Second Embodiment

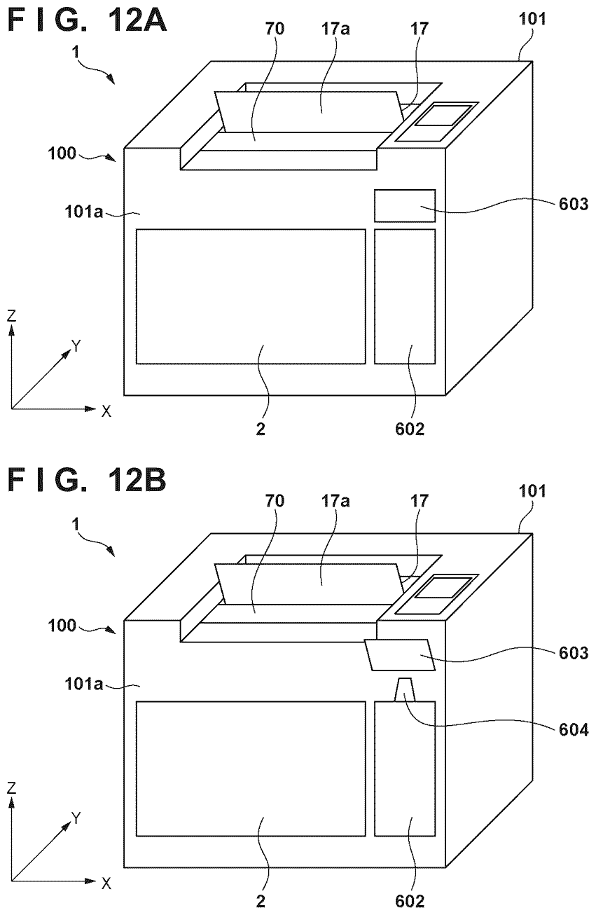

FIG. 12A is a view of the outer appearance of a printing apparatus 1 according to the second embodiment. In this embodiment, the printing apparatus 1 includes, at a front portion 101a, a storage cassette 2, a main tank 602, and an opening/closing cover 603. The main tank 602 is fixed to an apparatus main body 100. The opening/closing cover 603 is positioned above the main tank 602 and arranged to be openable/closable with respect to the apparatus main body 100. In the closed state, the opening/closing cover 603 seals an inlet 604 for injecting ink to the main tank 602.

FIG. 12B shows a state in which the opening/closing cover 603 is open and ink can be injected from the inlet 604. The user can open the opening/closing cover 603 to inject ink to the main tank 602 and replenish the main tank 602 with the ink. At this time, the storage cassette 2 is not detached, so access to the waste ink tank 500 by the user is restricted. Even in this embodiment, a recovery unit 51 may recover the function of a printhead 12 during replenishment with ink.

The main tank 602 is preferably constituted so that the remaining amount of ink is visible. Thus, before a notification representing that replenishment with ink is required is output, the user can perform replenishment with ink, properly implementing continuous printing.

### Others

In the embodiments, each element is named using an expression based on its main function. However, each function described in the embodiments may be a sub-function, and is not strictly limited to the expression. The expression can be replaced with another similar expression. In the same vein, an expression “unit or portion” can be replaced with “tool”, “component”, “member”, “structure”, “assembly”, or the like. Alternatively, these may be omitted or added.

In addition, two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B”may be used.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-157729, filed Sep. 11, 2024, which is hereby incorporated by reference herein in its entirety.

What is claimed is:

1. A printing apparatus comprising:
a printhead configured to print on a print medium; and
at least one conveyance unit configured to convey a print medium, the apparatus further comprising:
a storage cassette configured to store a print medium and be inserted/removed into/from an apparatus main body,
wherein the at least one conveyance unit includes a detachable unit configured to form part of a conveyance path of the print medium and be detachable from the apparatus main body,
the detachable unit is exposed by removing the storage cassette from the apparatus main body, and
the storage cassette is configured to be held at a second position at which the detachable unit can be detached from the apparatus main body in a case where the storage cassette is pulled out from a first position at which the storage cassette is inserted into the apparatus main body.

2. The apparatus according to claim 1, wherein the at least one conveyance unit includes a first conveyance unit configured to convey a print medium from the storage cassette to the printhead, and
the detachable unit forms part of the first conveyance unit.

3. The apparatus according to claim 1, wherein the printhead is configured to execute printing by discharging ink,
the printing apparatus further comprises a waste ink tank configured to store waste ink of the printhead and be detachable from the apparatus main body,
the waste ink tank is exposed by removing the storage cassette from the apparatus main body, and
the second position of the storage cassette is a position at which the waste ink tank can be further detached from the apparatus main body.

4. The apparatus according to claim 1, further comprising a slot configured to receive the storage cassette,
wherein the storage cassette includes an abutment portion configured to abut against a portion within the slot at the second position.

5. The apparatus according to claim 1, further comprising a slot configured to receive the storage cassette,
wherein an abutment portion against which the storage cassette abuts at the second position is provided within the slot.

6. The apparatus according to claim 4, wherein in a case where a direction of insertion/removal of the storage cassette is represented as a first direction,
a size of the detachable unit in the first direction is represented as N, and
a pullout amount of the storage cassette from the first position to the second position is represented as L,
the abutment portion is provided to establish N<L.

7. A printing apparatus comprising:
a printhead configured to print on a print medium by discharging ink;
a storage cassette configured to store a print medium and be inserted/removed into/from an apparatus main body; and
a waste ink tank configured to store waste ink of the printhead and be detachable from the apparatus main body,
wherein the waste ink tank is exposed by removing the storage cassette from the apparatus main body.

8. The apparatus according to claim 7, further comprising a recovery unit configured to recover a function of the printhead,
wherein whether recovery of the function by the recovery unit can be executed is not related to an insertion/removal state of the storage cassette with respect to the apparatus main body.

9. The apparatus according to claim 8, further comprising a notification unit configured to, in a case where the storage cassette is removed from the apparatus main body during execution of recovery of the function by the recovery unit, output a notification representing the removal of the storage cassette.

10. The apparatus according to claim 7, further comprising:
a recovery unit configured to recover a function of the printhead; and
an interruption unit configured to interrupt the recovery in execution in a case where the storage cassette is removed from the apparatus main body during execution of recovery of the function by the recovery unit.

11. The apparatus according to claim 7, wherein in a case where the storage cassette is removed from the apparatus main body during printing by the printhead, printing by the printhead continues.
